(19) United States
(12) Patent Application Publication
(10) Pub. No.: US 2007/0185612 A1
(43) Pub. Date: Aug. 9, 2007

(54) Systems and methods for managing inventory of aggregated post-consumer goods

(75) Inventors: S. Graham Stevens, Charlotte, NC (US); Christopher M. Scherer, Rutland, VT (US); Steven Gray, Deptford, NJ (US); James R. Wilborne, Charlotte, NC (US); Matthew B. Potter, Charlotte, NC (US); Scott D. Charter, Brandon, VT (US); Timothy A. Langlois, Fair Haven, VT (US)

Correspondence Address: WILMER CUTLER PICKERING HALE AND DORR LLP, 1875 PENNSYLVANIA AVE., NW, WASHINGTON, DC, 20004, US

(73) Assignee: Casella Waste Systems, Inc., Rutland, VT (US)

(21) Appl. No.: 11/349,120

(22) Filed: Feb. 8, 2006

(51) Int. Cl. G06F 7/00

(52) U.S. Cl. 700/215

(57) ABSTRACT

Systems and methods for placing a radio frequency identifier (RFID) tag on a bale, reading the RFID tag on the bale, and updating a storage repository that includes information pertaining to the bale. The systems and methods can be used to allow inventory management of bales for quality control.

### BACKGROUND OF THE INVENTION

1. Field of the Invention

Embodiments of the present invention relate to methods and systems for managing an inventory of aggregated material, such as bales.

2. Background Description

To meet the growing problem of post-consumer goods disposal, many recyclable post-consumer goods are collected from the curbside and sent to a Material Recovery Facility (MRF). MRFs, which began appearing in the 1980's, are facilities where mixed recyclable materials are sorted and baled for sale. Generally, co-mingled recyclable materials arrive at MRFs and can be sorted into individual material categories such as plastic, steel, aluminum, paper, cardboard, and the like. Subsequently, the sorted materials can be either sold as-is or sold after baling, where individual bales or other aggregations of material can weigh up to several tons. The post-consumer goods (either as-is or after baling) can be stored at a MRF until, for example, a buyer purchases them.

Post-consumer goods are sometimes baled because they can lower transportation costs, reduce required storage space in MRFs, and facilitate transportation to a desired customer, they are not always sold in a form. However, to minimize floor storage space, bales are generally stacked on top of each other. When stacked, large bales could potentially fall and seriously injure or even kill a person. Bales also may be moved from one stack to another for reasons such as accessing a bale for sale and/or relocating a bale to optimize storage space. When moved, bales are often turned and rotated, which may physically impact or jar baled material.

Regardless of whether post-consumer goods are baled or not prior to selling them to a customer, maintaining an inventory of such post-consumer goods poses significant challenges for MRFs. For example, due to the above-mentioned nature of storage and relocation of the bales, manually obtaining and keeping track of bale-specific information can be difficult and time-consuming.

FIG. 1, generally at 100, shows an example of a conventional method of managing an inventory of bales using barcode technology. As shown in FIG. 1, a bale may be created 10, and a barcode label may be placed on the bale 12. The barcode may be scanned 14 and information associated with the bale may be stored in a repository 16 such as, for example, a standard database. The bale may then be stored 18, as described above, and the inventory of bales in a MRF may be updated 20 by scanning one or more barcodes on a bale.

Although barcodes may provide a way to track bale-specific information, there are several drawbacks to this approach. For example, in order to update the inventory of all the bales in a MRF, the barcode labels of all the bales need to be scanned. However, as bales are turned and rotated, determining the location of the barcode(s) on bales, and subsequently scanning them may be a non-trivial process that is fraught with safety issues. Furthermore, the significant wear and tear of the bales during storage often leads to deterioration of the bar codes, which can result in an inability to scan such barcodes.

In addition, because bale-specific information cannot always be easily ascertained in conventional systems, many bales are sold largely based on accessibility of the bales at the time of shipment. Information pertaining to the grade or quality of the bales may not be provided or available prior to sale, resulting in many bales being rejected, returned to a MRF, and/or downgraded by a buyer. This forces MRFs to absorb the associated costs and/or charge lower prices for the bale.

Furthermore, ascertaining the status of a bale's shipment to a buyer may also be time-consuming and costly. For example, if a buyer inquires about the status of a bale, a MRF and/or a trucking firm may need to be consulted for each inquiry received from a buyer. Such an approach is labor intensive and therefore a costly way in which to provide desired feedback to a customer.

We have discovered a system that provides a solution to these heretofore unaddressed needs.

### SUMMARY OF EMBODIMENTS OF THE INVENTION

In accordance with one embodiment of the present invention, a method that can be used to facilitate, for example, inventory management of post-consumer goods includes placing at least one radio frequency identifier (RFID) tag on/in a group of products, reading the at least one RFID tag on the group of products, and updating a storage repository containing information pertaining to the bale.

In accordance with another embodiment of the present invention, a computer program product residing on a computer readable medium may contain instructions for causing a computer to read the at least one RFID tag on a group of products and update a storage repository containing information pertaining to the group of products.

### LIST OF FIGURES

The Detailed Description, including the description of a preferred structure as embodying features of the invention will be best understood when read in reference to the accompanying figures wherein:

FIG. 1 is a flow chart of a conventional method of managing an inventory of bales;

FIG. 2 is a system for managing an inventory of groups of products in accordance with an embodiment of the present invention;

FIG. 3 is method for managing an inventory of groups of products in accordance with an embodiment of the present invention;

FIG. 4 is a flow chart showing additional steps that can be utilized in connection with FIG. 3 in accordance with an embodiment of the present invention; and

FIGS. 5A-5D are examples of a repository that may be updated while maintaining an inventory of unbaled, aggregated products in accordance with an embodiment of the present invention.

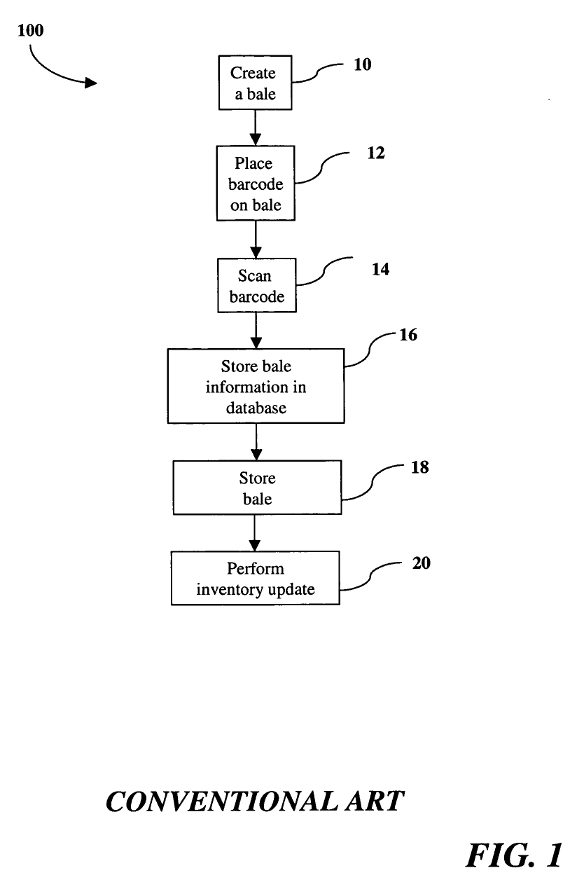

### DETAILED DESCRIPTION OF EMBODIMENTS OF THE INVENTION

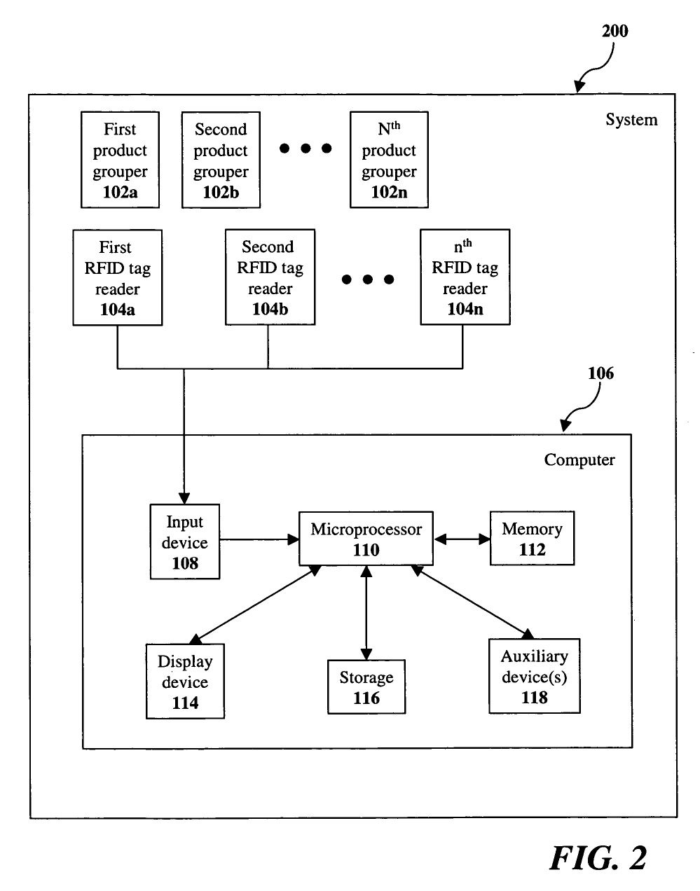

FIG. 2, generally at 200, shows a system for managing an inventory of groups of products in accordance with certain embodiments of the present invention. As illustrated, system 200 may include a plurality of product groupers 102a-102n, a plurality of radio frequency identification (RFID) tag readers 104a-104n, and a standard general purpose computer 106. For example, a product grouper may be a baler, sorter, and the like. Computer system 106 may be composed of at least one input device 108 such as a standard keyboard and/or mouse, a microprocessor 110, a memory 112, a display device 114, a storage 116, and one or more auxiliary devices 118 such as a speaker. One or more systems 200 may be associated with or located within a facility such as a MRF.

RFID tag readers 104a-104n may include (or utilize) an antenna and a coupler. The antenna may receive and transmit radio frequency waveforms to respectively read and write data from/to an RFID tag, and provides the ability to add or update information stored in the RFID tags. RFID tags can be either active or passive. An active tag can initiate communication with a RFID tag reader and generally has its own power supply. A passive RFID tag generally does not have a separate power supply and may provide information to an RFID tag reader when the RFID tag reader sends a query. The antenna can transmit information obtained from a RFID tag to a standard coupler, wherein the coupler can control data acquisition and communication between a RFID tag and RFID tag readers 104a-104n. It should further be noted that, unlike barcode systems, a direct line-of-sight is generally not needed between a RFID tag and RFID tag readers 104a-104n because RFID systems utilize radio frequencies.

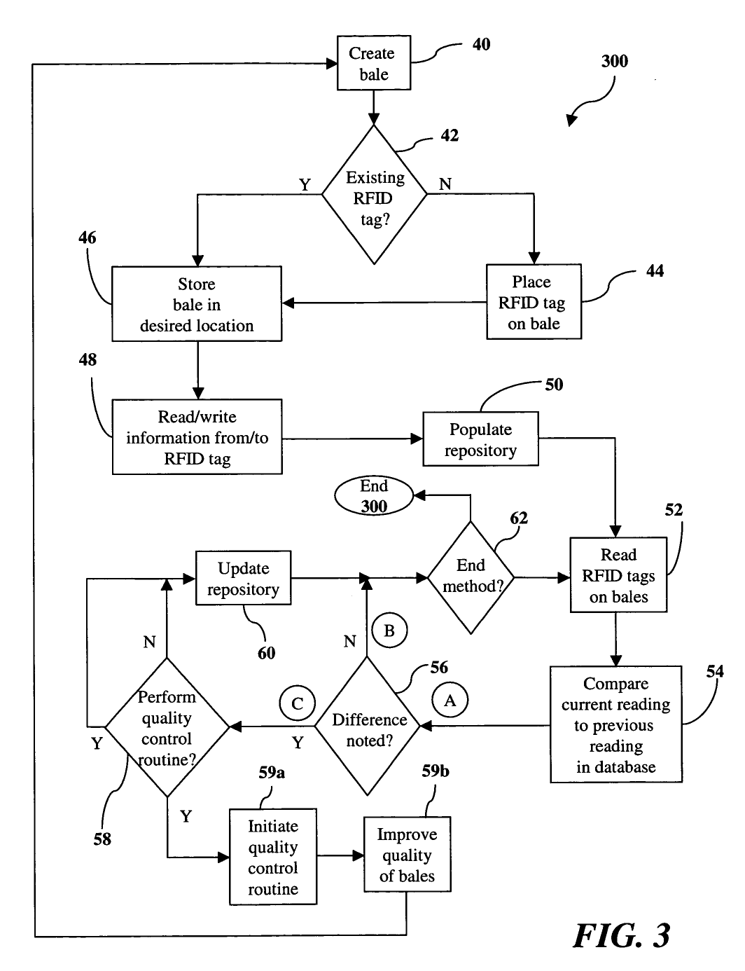

To illustrate certain embodiments of the present invention, FIG. 3, generally at 300, shows a method for managing an inventory of bales in accordance with an embodiment of the present invention. Initially, one or more balers 102a-102n may be utilized to create a bale 40. Once a bale is created, an RFID tag reader 104a may be utilized at decision step 42 to determine whether at least one functioning RFID tag already exists within the created bale. If a functioning RFID tag is not found, an RFID tag may be placed on the bale 44. If it is determined at decision step 42 that a RFID tag pre-exists in the bale or after an RFID tag has been placed on the bale 44, the bale may be stored in a desired location 46. In an alternate embodiment of the present invention, decision step 42 may be eliminated, and an RFID tag may be placed on the bale, as shown in step 44, regardless of whether or not an RFID tag pre-exists in the bale.

At step 48, information such as, for example, a time and date the bale was created, a quality of the bale, a baler operator, a location of the bale, the compression force used by baler 102a-102n during baling, weather conditions, as well as other desired information may be stored in the RFID tag and read by one or more RFID tag readers 104a-104n. At step 50, a repository (e.g. storage 116) stored in or utilized in conjunction with computer 106 may be updated with the bale-specific information. Standard database software, for example, may be utilized. The inventory repository of bales in a facility may then be monitored and updated.

For example, at step 52, RFID tags of all bales in the storage facility may be read using at least one of RFID tag readers 104a-104n. At step 54, the information obtained from a current reading may be compared with information obtained from, for example, a previous reading to determine, at decision step 56, whether any differences exist.

If a difference is not determined at decision step 56, method 300 may return to step 52 unless a user desires to end method 300 at step 62. If at least one difference is determined at decision step 56, decision step 58 may determine whether a quality control routine is required. The determination of decision step 58 may be based on an output provided by decision step 56.

If decision step 58 determines that quality control routine may be required, quality control routine may be initiated at step 59a. For example, computer 106 may alert a MRF manager that a bale has been returned and one or more reasons why a bale has been returned by a buyer (e.g., failing to meet the buyer's desired quality specifications) should be determined. Alternatively, computer 106 may determine that the particular buyer desires higher or lower compression force during baling and alert baler operator of the buyer's desires. Accordingly, quality of bales can be improved 59b. For example, if a buyer desires a higher compression force to be utilized during baling, this information can be stored in computer 106 and retrieved during a subsequent step 40 when a new bale is created for that particular buyer.

After decision step 58, the inventory repository may be automatically updated 60 by computer 106 based on a current reading. For example, RFID tag readers 104a-104n may send information obtained from a current reading to computer 106 via input device 108 to update the inventory repository. Quality control routine 59a-59b may be carried out before, concurrently with, or after the repository is updated in step 60. For example, quality control routine 59a-59b may be carried out a few weeks after decision step 58 has determined that quality control routine 59a-59b should be performed, while step 60 is carried out immediately or soon after decision step 58. After step 60, method 300 may return to step 52 unless a user desires to end method 300 at decision step 62.

It should be noted that quality control routine 59a-59b may utilize the most recent quality control list generated in decision step 56. However, a user may add any additional quality control tasks to the quality control list at any desired time to carry out quality control routine 59a-59b.

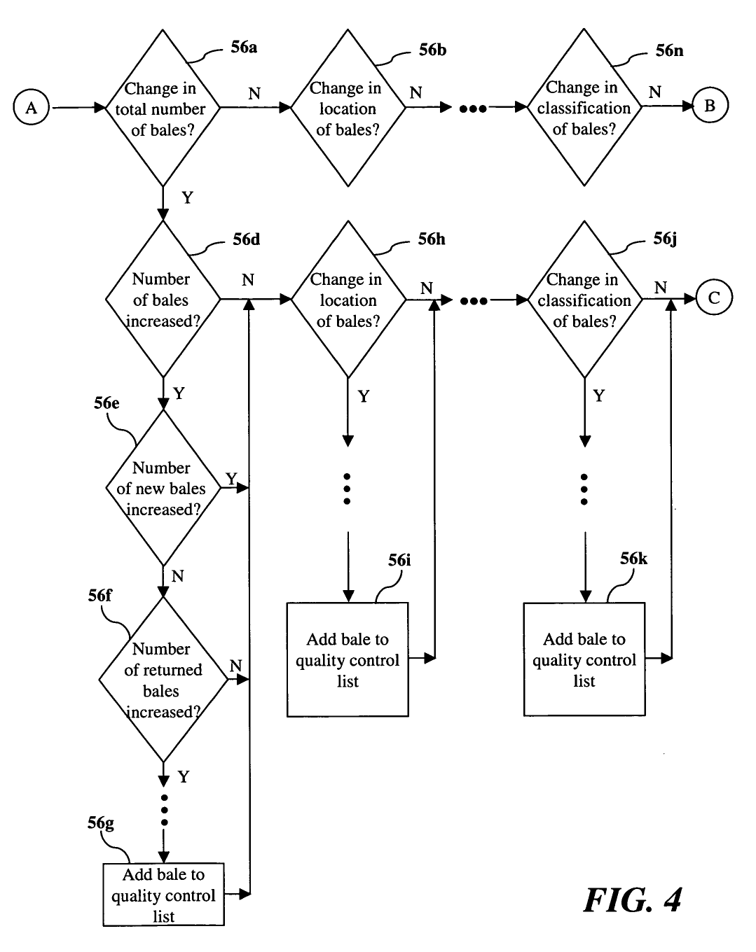

FIG. 4 shows additional steps that can be utilized in connection with FIG. 3 in accordance with certain embodiments of the present invention. For example, a difference in total number of bales between a previous reading and a current reading may be determined 56a. If a difference is not detected, a difference in location of one or more bales between a previous reading and a current reading may be determined at decision step 56b. Again, if a difference is not detected, a change in classification (quality) of one or more bales between a previous reading and a current reading may be determined at decision step 56n. Other differences may also, of course, be determined between steps 56a and 56n. If differences are not determined in any of decision steps 56a-56n, method 300 may return to step 52, unless a user desires to end method 300 in step 62, as shown in FIG. 3.

However, if, at decision step 56a, a difference in total number of bales between a prior reading and a current reading is determined, a further determination may be made at decision step 56d as to whether the number of bales has increased between a previous reading and a current reading. If an increase in the number of bales is not determined at decision step 56d, a difference in location of one or more bales between a previous reading and a current reading may be determined at decision step 56h. If, at decision step 56h, it has been determined that there has not been a change in location of one or more bales, a determination may be made at decision step 56j as to whether classification (quality) of one or more bales has changed. Other differences may also, of course, be determined by decision steps 56h-56j. After all the desired differences have been determined between decision steps 56d-56j, decision step 58 may determine that quality control routine 59a may not be required as the difference may simply be due to sale of one or more bales, and the repository may be updated 60 without carrying out quality control routine 59a-59b.

Returning to decision step 56d, if an increase in the number of bales is detected, a determination may be made at decision step 56e as to whether there has been an increase in the number of new bales. If an increase in number of new bales is determined at decision step 56e, decision step 56h may be carried out. However, if it has been determined at decision step 56e that there has not been an increase in the number of new bales, then, at decision step 56f, a determination may be made as to whether number of returned bales has increased.

If it has been determined at decision step 56f that there has not been an increase in the number of returned bales, decision step 56h may be carried out. However, if it has been determined at decision step 56f that there has been an increase in the number of returned bales, then, at step 56g, information pertaining to one or more returned bales may then be added to a quality control list to assess why a bale was returned by a buyer. Quality control routine 59a-59b may utilize the quality control list produced in step 56g if decision step 58 determines quality control routine 59a-59b should be performed. Other differences may also, of course, be determined between steps 56f-56g.

After step 56g, a determination can be made at decision step 56h as to whether the location of one or more bales has changed between a previous reading and a current reading. For example, in a previous reading, RFID tag reader 104b, corresponding to location B, may read a particular RFID tag. In a current reading, RFID tag reader 104d, corresponding to location D, may read the same RFID tag. Different RFID tag readers 104b and 104d may read the same RFID tag due to the proximity of the RFID tag to the respective RFID tag readers. As such, reading the same RFID tag by two different RFID tag readers may indicate that the bale has been moved to a different location, and information pertaining to one or more bales that changed location between a previous reading and a current reading may be added to a quality control list 56i. If it is determined at decision step 58 that quality control routine 59a-59b should be performed, quality control routine 59a-59b may utilize the quality control list produced in step 56i. Other differences may also, of course, be determined between steps 56h-56i.

After step 56i, a determination may be made at decision step 56j as to whether the classification of a bale has been changed between a previous reading and a current reading. For example, the facility may have had a leak overnight and one or more paper bales near RFID tag reader 104d in location D may have been downgraded from a high quality bale to a poor quality bale. RFID tag reader 104d may write in all the RFID tag readers in location D that the quality of paper bales in this location has a lower quality. Accordingly, this difference in classification may be determined between a prior reading and a current reading, and information pertaining to one or more bales that changed in classification between a previous reading and a current reading may be added to a quality control list 56k, wherein quality control routine 59a-59b may utilize the quality control list produced in step 56k. Other differences may also, of course, be determined between decision steps 56h and 56j and between steps 56j and 56k.

Another example illustrating a use of certain embodiments of the present invention may be maintaining an inventory of a group of products, such as newspaper received at a MRF. On a first day, a MRF may receive ten tons of newspaper that are dry and from Manhattan. To track this group of newspapers, ten RFID tags may be randomly inserted into the group of products and various conditions such as dryness, originating locale, delivery personnel, time and date received, and the like may be written to the RFID tags. A name, for example “A,” may also be generated and written to the RFID tags. The RFID tags may be randomly placed so that each RFID tag can represent, for example, about 1 ton of newspaper.

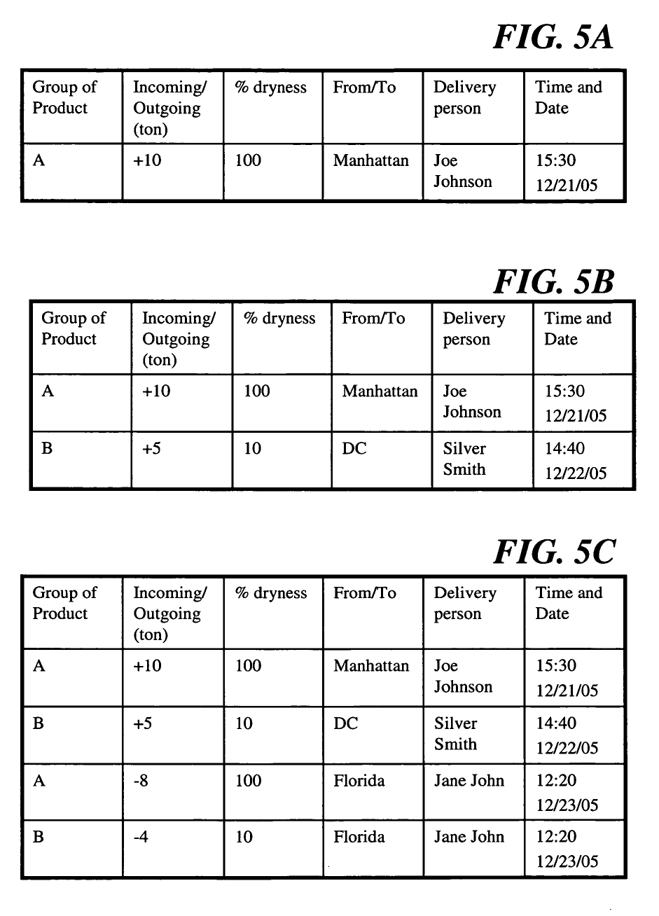

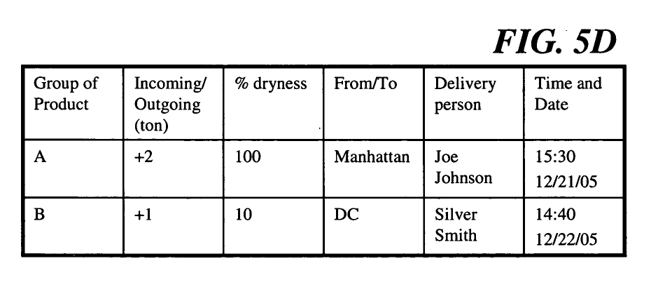

One or more RFID tag readers may then read the information stored in the RFID tags, transfer the read data to a repository via a network, such as a wireless network, and a computer may store the data received in a repository. For example, a repository for newspapers, as shown in FIG. 5A, may be created.

Next day, the MRF may receive from Washington, D.C. an additional five tons of newspaper that are wet. To track this second group of newspapers, five RFID tags may be randomly inserted into the group of products and various conditions such as dryness, originating locale, type of contamination, delivery personnel, time and date received may be written to the RFID tags. A name, for example “B,” may also be generated and written to the RFID tags. The RFID tags may be randomly placed so that each RFID tag can represent about 1 ton of newspaper.

One or more RFID tag readers may then read the information stored in the RFID tags, transfer the read data to a repository via a network, such as a wireless network, and a computer may store the data received in a repository. For example, a repository for newspapers, as shown in FIG. 5B, may be created.

Third day, the MRF may receive an order from a customer requesting 12 tons of newspaper. If the customer specifies that all 12 tons must be dry, the operator may be quickly determine that this order cannot be fulfilled at the present and inform the customer. However, if the customer specifies that 8 tons of the newspaper must be dry and 4 tons of the newspaper must be very wet, the operator may be able to say that order can be satisfied right away and 8 tons from group of newspapers “A” and 4 tons from group of newspaper “B” may be delivered to the customer in Florida. The delivery person and the time of pickup may be entered into repository as shown in FIG. 5C.

Subsequently, when the customer informs the operator that the order has been received, or if the operator no longer wishes to maintain information regarding orders that have been shipped to customers, the repository may be updated as shown in FIG. 5D.

Statistical analysis may also be performed. For example, at the end of day 2, it is known that ⅔ of the inventory is dry and ⅓ of the inventory is wet. If the newspaper is not divided into discrete sections of “wet” and “day,” a potential purchaser can be informed that any purchase will likely be ⅔ dry and ⅓, wet, with potential deviations therefrom.

It should be noted that in the example provided above, the group of products are not limited to being a newspaper, but may be any post-consumer goods. For example, rather than receiving dry or wet newspaper, a MRF may receive five tons of flint (clear) glass the first day, receive three tons of green glass the next day and two tons of amber glass the third day. An inventory of these groups of products may be maintained in an analogous manner as described above.

Upon review of the description and embodiments of the present invention, those skilled in the art will understand that modifications and equivalent substitutions may be performed in carrying out the invention without departing from the essence and spirit of the invention. Thus the invention is not meant to be limiting by the embodiments explicitly described above, and is limited only by the claims which follow.

1. A method comprising:
a) placing at least one radio frequency identifier (RFID) tags on a group of products;
b) reading the at least one RFID tags on the group of products; and
c) updating a storage repository comprising information pertaining to the groups of products.

2. The method of claim 1, wherein the group of products is a bale.

3. The method of claim 2, further comprising:
d) repeating step b); and
e) repeating step c).

4. The method of claim 3, further comprising:
f) comparing information collected in step c) with information collected in step e).

5. The method of claim 4, further comprising:
g) performing one or more quality control routines if the information collected in step c) is different from the information collected in step e).

6. The method of claim 4, wherein said comparing comprises at least one of:
i) determining a change in a total number of bales;
ii) determining a change in a location of one or more bales; and
iii) determining a change in a number of bales in a classification.

7. The method of claim 2, wherein said storage repository comprises at least one classification for the bale.

8. The method of claim 7, wherein said classification comprises at least one of a quality of bale, a baler operator, a pressure applied by a baler during a baling operation, a location of a bale during a baling operation, a date of a baling operation, a time of a baling operation, and a weather condition during a baling operation.

9. The method of claim 2, wherein said at least one RFID tag comprises information pertaining to at least one of a quality of bale, a baler operator, a pressure applied by a baler during a baling operation, a location of the bale, a date of a baling operation, a time of a baling operation, and a weather condition during a baling operation.

10. The method of claim 1, further comprising writing at least one information pertaining to the groups of products to the at least one RFID tags.

11. A computer program product residing on a computer readable medium, the computer program product comprising instructions for causing a computer to:
a) read at least one radio frequency identifier (RFID) tag on a group of products;
b) update a storage repository comprising information pertaining to the group of products.

12. The computer program product of claim 11, wherein the group of products is a bale.

13. The computer program product of claim 12, further comprising instructions for causing a computer to:
c) repeat instruction a); and
d) repeat instruction b).

14. The computer program product of claim 13, further comprising instructions for causing a computer to:
e) compare information collected in step b) with information collected in instruction d).

15. The computer program product of claim 14, further comprising instructions for causing a computer to:
f) perform one or more quality control routines if the information collected in instruction b) is different from the information collected in instruction d).

16. The computer program product of claim 12, wherein said comparing instructions comprise instructions for causing a computer to:
i) determine a change in total number of bales;
ii) determine a change in location of one or more bales; and
iii) determine a change in number of bales in a classification.

17. The computer program product of claim 12, wherein said storage repository instructions comprise instructions to assign at least one classification for the bale.

18. The computer program product of claim 17, wherein said classification instructions comprise at least one of a quality of bale, a baler operator, a pressure of baler, a location of the bale, a date, a time, and a weather condition.

19. The computer program product of claim 12, wherein said reading instructions comprise instructions to read from an RFID tag at least one of a quality of bale, a baler operator, a pressure of baler, a location of the bale, a date, a time, and a weather condition.

20. The computer program product of claim 11, further comprising instructions for causing a computer to write at least one information pertaining to the group of products to the at least one RFID tags.
